(19) United States
(12) Patent Application Publication
(10) Pub. No.: US 2021/0246034 A1
(43) Pub. Date: Aug. 12, 2021

(54) METHOD AND APPARATUS FOR PRODUCING CARBON MONOXIDE

(71) Applicant: TEKNOLOGIAN TUTKIMUSKESKUS VTT OY, Espoo (FI)

(72) Inventors: Noora KAISALO, Espoo (FI); Pekka SIMELL, Espoo (FI); Christian FRILUND, Espoo (FI); Francisco VIDAL VAZQUEZ, Espoo (FI); Ilkka HANNULA, Espoo (FI)

(73) Assignee: TEKNOLOGIAN TUTKIMUSKESKUS VTT OY, Espoo (FI)

(21) Appl. No.: 16/980,132

(22) PCT Filed: Mar. 12, 2019
(86) PCT No.: PCT/FI2019/050204

§ 371 Date: Sep. 11, 2020

(30) Foreign Application Priority Data
Mar. 13, 2018 (FI) 20185232

(51) Int. Cl. C01B 32/40; C01B 3/38; C10G 2/00; B01J 8/04; B01J 8/06

(52) U.S. Cl. CPC C01B 32/40; B01J 2208/00548; C01B 3/386; C10G 2/40; B01J 8/0492; B01J 8/06; C01B 2203/0495; C01B 2203/061; C01B 2203/062; C01B 2203/0872; C01B 2203/1058; C01B 2203/1064; C01B 2203/148; B01J 2208/00017; B01J 2208/00539; C01B 3/382

(57) ABSTRACT

A method and apparatus for producing carbon monoxide, wherein the carbon monoxide is formed from a gaseous feed which includes at least carbon dioxide. The method includes supplying oxygen to a carbon dioxide stream for forming a carbon dioxide based mixture, supplying the carbon dioxide based mixture to a hydrogen based stream to form the gaseous feed, supplying a hydrocarbon containing stream to the hydrogen based stream before the supply of the carbon dioxide based mixture, feeding the gaseous feed into a reactor which includes at least one catalyst, treating the gaseous feed by partial oxidation in the reactor so that carbon dioxide reacts with hydrogen in the reactor in presence of oxygen and heat is formed during the reaction, and recovering a product composition including at least carbon monoxide and hydrogen from the reactor.

### FIELD

The application relates to a method defined in claim 1 and an apparatus defined in claim 12 for producing carbon monoxide. Further, the application relates to a use of the method defined in claim 17.

### BACKGROUND

Known from the prior art is to produce hydro-carbons by a Fischer-Tropsch synthesis. The Fischer-Tropsch synthesis requires a mixture of H₂ and CO as feed.

Further, it is known from the prior art that carbon dioxide may be converted to carbon monoxide by RWGS (reverse water gas shift) reaction

### OBJECTIVE

The objective is to disclose a new type method and apparatus for producing carbon monoxide from carbon dioxide. Further, the objective is to disclose a new type method and apparatus for treating carbon dioxide streams. Further, the objective is to improve a Fischer-Tropsch synthesis.

### SUMMARY

The method and apparatus and use are characterized by what are presented in the claims.

### BRIEF DESCRIPTION OF THE DRAWINGS

The accompanying drawings, which are included to provide a further understanding of the invention and constitutes a part of this specification, illustrate some embodiments of the invention and together with the description help to explain the principles of the invention. In the drawings:

FIG. 1 is a flow chart illustration of a process according to one embodiment, and

FIG. 2 is a flow chart illustration of a process according to another embodiment.

### DETAILED DESCRIPTION

In a method for producing carbon monoxide (CO), wherein the carbon monoxide is formed from a gaseous feed (1) which comprises at least carbon dioxide, wherein the method comprises supplying oxygen (2) to a carbon dioxide stream (3) for forming a carbon dioxide based mixture (4), supplying the carbon dioxide based mixture (4) to a hydrogen based stream (5) to form the gaseous feed (1), supplying a hydrocarbon containing stream (6) to the hydrogen based stream (5) before the supply of the carbon dioxide based mixture (4), feeding the gaseous feed into a reactor (7) which comprises at least one catalyst, treating the gaseous feed by means of a partial oxidation in the reactor (7) so that carbon dioxide reacts with hydrogen in the reactor in presence of oxygen and heat is formed during the reaction, and recovering a product composition (8) comprising at least carbon monoxide and hydrogen from the reactor (7). Preferably carbon dioxide is converted to carbon monoxide during the reaction in the reactor (7).

An apparatus for producing carbon monoxide comprises feeding devices for supplying oxygen (2) to a carbon dioxide stream (3) for forming a carbon dioxide based mixture (4), for supplying the carbon dioxide based mixture (4) to a hydrogen based stream (5) to form the gaseous feed (1) and for supplying a hydrocarbon containing stream (6) to the hydrogen based stream (5) before the supply of the carbon dioxide based mixture (4) and for feeding the gaseous feed (1) into a reactor (7), at least one reactor (7) which comprises at least one catalyst and to which the gaseous feed (1) is supplied and in which the gaseous feed is treated by means of a partial oxidation so that carbon dioxide reacts with hydrogen in the reactor in presence of oxygen and heat is formed during the reaction, and at least one recovering device for recovering a product composition (8) comprising at least carbon monoxide and hydrogen from the reactor (7).

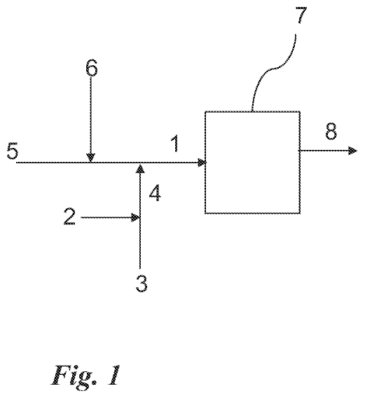

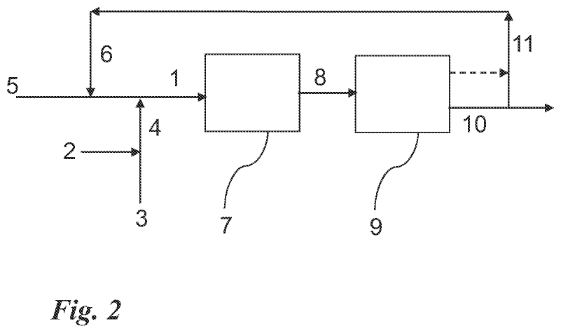

One embodiment of the method and the apparatus is shown in FIG. 1. Another embodiment of the method and the apparatus is shown in FIG. 2.

Preferably, the feed of the reactor (7) is in gaseous form. In one embodiment, the gaseous feed (1) comprises at least carbon dioxide, oxygen, hydrogen and hydrocarbons. The gaseous feed (1) may contain also other compounds. In this context, the gaseous feed (1) means any feed into the reactor (7) in which a partial oxidation is carried out and carbon dioxide is converted to carbon monoxide. The gaseous feed (1) can be supplied to a catalyst bed of the reactor (7). In one embodiment, the gaseous feed is treated before the supply into the reactor.

In this context, the hydrocarbon containing stream (6) means any stream which comprises at least hydrocarbons. In one embodiment, the hydrocarbon containing stream (6) comprises light hydrocarbons, preferably C1-C6 hydrocarbons. In one embodiment, the hydrocarbon containing stream (6) comprises hydrocarbons which are C1-C30 hydrocarbons. In one embodiment, the hydrocarbon containing stream (6) comprises hydrocarbons and, further, hydrogen, carbon monoxide and/or carbon dioxide.

Preferably the gaseous feed (1) comprises carbon dioxide, i.e. carbon dioxide stream (3). In this context, the carbon dioxide stream (3) means any carbon dioxide stream or carbon dioxide based stream. In one embodiment, the carbon dioxide stream (3) contains at least carbon dioxide, and it may contain also a little amount of hydrocarbons.

Preferably the gaseous feed (1) comprises oxygen (2). In one embodiment, an amount of the oxygen (2) which is supplied to the carbon dioxide stream (3) is based on process conditions and/or a desired product distribution.

In this context, the hydrogen based stream (5) means any stream which comprises hydrogen. Preferably, the hydrogen based stream comprises mainly hydrogen, i.e. it mainly consists of hydrogen.

In one embodiment, the hydrocarbon containing stream (6) is mixed with the hydrogen based stream (5) and to this feed the carbon dioxide based mixture (4) is added for forming the gaseous feed (1). The whole gaseous feed (1) is fed to the reactor (7).

In one embodiment, the gaseous feed (1) is fed with high velocity to the reactor (7), such as to a catalyst bed of the reactor (7), such that the velocity of the gaseous feed, i.e. gas stream, is ≥0.5 m/s. In one embodiment the velocity of the gas stream is about 1 m/s. In one embodiment the velocity of the gas stream is over 1 m/s. Then the hotpots are prevented in the reactor feed and in the reactor. Further, it is important to feed the oxygen together with carbon dioxide.

In one embodiment, the reactor (7) is a tube reactor or tubular reactor. In one embodiment, the reactor is a partial oxidation reactor in which the partial oxidation is carried out. In one embodiment, the reactor is a catalytic partial oxidation (CPDX) reactor. Preferably, carbon dioxide is converted to carbon monoxide in the reactor. In one embodiment, the reactor is a CPDX reactor in which RWGS reaction (reverse water gas shift reaction) is also carried out. In one embodiment, hydrogen rich syngas is formed in the reactor, such as in the CPDX reactor. In one embodiment, the reactor (7) is surrounded by an insulating covering, preferably for maintaining heat in the reactor.

In one embodiment, the treatment temperature is 800-1500° C. in the reactor (7). In one embodiment, the treatment temperature is preferably over 800° C. In one embodiment, the treatment temperature is 800-1000° C., and in one embodiment 800-950° C. Preferably, the heat is formed during the partial oxidation reaction in the reactor (7). In one embodiment, the reaction is started by heating, e.g. by means of an external heat device, in the reactor (7).

In one embodiment, pressure in the reactor (7) is 15-30 bar, and in one embodiment 17-25 bar. In one embodiment, the pressure is preferably about 20 bar.

In one embodiment, the catalyst comprises at least one catalyst agent on a carrier material, and the catalyst agent is selected from a metal of the noble metal group, e.g. Rh, and/or a transition metal group, e.g. Fe, Co, Ni. In one embodiment, the carrier material can be any suitable carrier material, e.g. Al₂O₃, or ZrO₂ based carrier material or other suitable carrier material which endures high temperatures. In one embodiment, the catalyst is Rh/Al₂O₃ catalyst. In one embodiment, the catalyst is NiRh/Al₂O₃ catalyst. In one embodiment, the catalyst is Ni/Al₂O₃ catalyst. In one embodiment, the catalyst is selected from Rh/Al₂O₃ catalyst, NiRh/Al₂O₃ catalyst and Ni/Al₂O₃ catalyst. Alternatively other suitable catalyst can be used. In one embodiment, the catalyst is arranged as a coating on a substrate, e.g. as a washcoating, onto a metal surface, such as metal monolith, or ceramic surface, such as ceramic monolith.

The partial oxidation is carried out in the reactor (7). Preferably, the partial oxidation is an exothermic reaction. Preferably, also the carbon monoxide is formed from carbon dioxide in the reactor (7). In one embodiment, also a reverse water gas shift (RWGS) reaction is carried out in the reactor in order to convert carbon dioxide to carbon monoxide. The reverse water gas shift (RWGS) reaction is an endothermic reaction. Preferably, the partial oxidation reaction brings the necessary heat for the reaction in which carbon dioxide is converted to carbon monoxide. Preferably, the invention is based on the combination of the partial oxidation reaction and the reaction for converting carbon dioxide to carbon monoxide. In one embodiment, the invention is based on a combined CPDX and RWGS reactor.

In this context, the product composition (8) means any product from the reactor (7). The product composition comprises one or more product components, e.g. carbon monoxide, hydrogen, water and/or other components. Preferably the product composition contains at least carbon monoxide and hydrogen. In one embodiment, the product composition contains also water. The product composition may contain also other components. In one embodiment, the product composition mainly consists of carbon monoxide and hydrogen. In one embodiment, the product composition can be post-treated after the reactor (7). In one embodiment, the product composition can be supplied to a desired treatment process, e.g. to a Fischer-Tropsch process. In one embodiment, the product composition is a syngas which can be supplied to the Fischer-Tropsch (FT) process. In one embodiment, water may be removed from the product composition after the reactor (7).

In one embodiment, the product distribution of the product composition (8) is adjusted by means of the components in the gaseous feed (1) and amounts of said components. In one embodiment, the product distribution is adjusted based on a synthesis after the reactor (7), for example for adjusting suitable feed to the synthesis or for adjusting H₂/CO ratio.

In one embodiment, the product composition (8) is cooled after the reactor (7). In one embodiment, the product composition (8) is cooled to temperature of 4-300° C., and in one embodiment to about 250° C. In one embodiment, water of the product composition (8) may be condensed in a condenser.

In one embodiment, the product composition (8) is used as a feed to a synthesis process, such as to a Fischer-Tropsch (FT) process, or a methanation, or a production of methanol, or to another suitable process.

In one embodiment, the apparatus comprises at least one Fischer-Tropsch reactor (9), i.e. FT reactor (9), into which the product composition (8) is supplied. Any suitable Fischer-Tropsch (FT) reactor known per se can be used as the Fischer-Tropsch reactor in the apparatus.

In one embodiment, the product composition (8) is supplied as the feed to a Fischer-Tropsch step, such as to a Fischer-Tropsch reactor (9). In one embodiment, carbon monoxide and hydrogen are supplied from the reactor (7) to the Fischer-Tropsch reactor (9). In one embodiment, the product composition (8) can be treated before the supply to the Fischer-Tropsch reactor (9).

Preferably, the Fischer-Tropsch (FT) reaction is an exothermic reaction in which carbon monoxide reacts with hydrogen. In one embodiment, paraffin-rich hydrocarbons which can be considered as heavy hydrocarbons are formed from the carbon monoxide and hydrogen in the Fischer-Tropsch (FT) reaction. In one embodiment, the Fischer-Tropsch reaction is carried out by means of Co-based catalyst or Fe-based catalyst in the Fischer-Tropsch (FT) reactor (9). Alternatively, the FT reaction can be made with other suitable catalyst.

In one embodiment, the Fischer-Tropsch reaction is carried out at temperature which is 150-350° C., in one embodiment 200-300° C. In one embodiment, pressure is 15-25 bar, in one embodiment about 20 bar, during the FT reaction. In one embodiment, the Fischer-Tropsch reaction takes place at around 20 bar pressure and around 200-300° C.

In one embodiment, the product (10) of the Fischer-Tropsch (FT) step is a mixture of hydrocarbons. In one embodiment, the product of the FT comprises at least hydrocarbons, e.g. C5-C60 hydrocarbons. In one embodiment, the product of the FT comprises desired components, such as oil and wax components, and undesired components, such as water, light hydrocarbons, unreacted feed components and/or non-condensable components or their combinations. In one embodiment, the non-condensable components are discharged as an off-gas stream (11) from the FT step, e.g. from the FT reactor. In one embodiment, the product of the FT comprises also other organic compounds.

In one embodiment, H₂/CO ratio in the FT reaction can be adjusted by means of an amount of hydrogen feed to the FT reactor and/or by means of the components and the amount of the components in the gaseous feed to the partial oxidation reactor.

In one embodiment, the off-gas stream (11) comprising at least hydrocarbons from the FT step or FT reactor (9) is recycled and is used as the hydrocarbon containing stream (6) in the feed of the partial oxidation reactor (7). In this context, the off-gas stream means any off-gas or tail gas or other undesired gas from the FT step or FT reactor. Preferably the off-gas stream comprises undesired components, such as light hydrocarbons, unreacted feed components, non-condensable components or their combinations, of the FT process product. Further, the off-gas stream can comprise water. In one embodiment, the off-gas stream comprises light hydrocarbons, preferably C1-C6 hydrocarbons. In one embodiment, the off-gas stream comprises hydrocarbons and, further, hydrogen, carbon monoxide and/or carbon dioxide.

In one embodiment, the apparatus comprises at least one recirculation device for recycling the off-gas stream (11) comprising at least hydrocarbons from the Fischer-Tropsch step and for using the off-gas stream as the hydrocarbon containing stream (6).

In one embodiment, the off-gas stream (11) of the FT reactor (9) is recycled and is used as the hydrocarbon containing stream (6) in the feed of the partial oxidation reactor (7), such as catalytic partial oxidation reactor (CPDX), and the product composition (8) from the partial oxidation reactor (7) is supplied to the FT reactor (9). Then the off-gases of the FT reactor can be recirculated to the partial oxidation reactor in which the off-gases can be processed to syngas, such as carbon monoxide. In one embodiment, the partial oxidation reactor (7), such CPDX reactor, is operated at the same pressure as the FT reactor (9) wherein the off-gas recirculation can be utilized better.

In one embodiment, the method comprises more than one partial oxidation steps. In one embodiment, the apparatus comprises more than one partial oxidation reactors (7). In one embodiment, the method comprises one partial oxidation step. In one embodiment, the apparatus comprises one partial oxidation reactor (7). In one embodiment, at least two reactors (7) are arranged in parallel. In one embodiment, at least two reactors (7) are arranged sequentially.

In one embodiment, the method comprises more than one Fischer-Tropsch process steps. In one embodiment, the apparatus comprises more than one FT reactors (9). In one embodiment, the method comprises one Fischer-Tropsch process step. In one embodiment, the apparatus comprises one FT reactor (9). In one embodiment, at least two reactors (9) are arranged in parallel. In one embodiment, at least two reactors (9) are arranged sequentially.

In one embodiment, the apparatus comprises at least one outlet for discharging the product composition (8) out from the reactor (7).

In one embodiment, the apparatus comprises at least one feed inlet for supplying the gaseous feed (1) into the reactor (7).

In one embodiment, the apparatus comprises at least one outlet of the FT reactor for discharging the product (10) of the FT reactor (9) out from the FT reactor (9).

In one embodiment, the apparatus comprises at least one feed inlet of the FT reactor for supplying the product composition (8) of the reactor (7) into the FT reactor (9).

The feed inlet may be any suitable inlet known per se, e.g. pipe, port or the like. The product outlet may be any suitable outlet known per se, e.g. pipe, outlet port or the like.

Preferably, the apparatus comprises at least one feeding device. In this context, the feeding device can be any feeding device, equipment or other suitable device. In one embodiment, the feeding device is selected from the group comprising pump, compressor, tube, pipe, other suitable feeding device and their combinations.

In one embodiment, the method is based on a continuous process. In one embodiment, the apparatus is a continuous apparatus. In one embodiment, the method is based on a batch process. In one embodiment, the apparatus is a batch apparatus.

In one embodiment, the apparatus and the method is used and utilized in a production of hydrocarbons, Fischer-Tropsch (FT) process, treatment of carbon dioxide, carbon dioxide capture process, catalytic partial oxidation (CPDX) process, methanation process, production of methanol, or their combinations.

Thanks to the invention carbon dioxide based feed can be treated and converted easily and effectively. The partial oxidation also brings the necessary heat for the reaction in which carbon dioxide is converted to carbon monoxide. When the oxygen is fed to carbon dioxide stream, the reaction of the oxygen and the burning can be prevented such that the reactions do not take place too quickly. Then it can be ensured that the reactions take place with the catalyst in the reactor, not before the catalyst. It is desirable that the oxygen does not react until in connection with the catalyst in the reactor. By means of the invention carbon dioxide can be used as a feed for a FT process. Further, non-condensable products, such as off-gases, of the FT process can be utilized and recirculated to the partial oxidation process. By means of said recirculation the yield of oils and waxes can be improved in the FT process. Further, the invention helps controlling the carbon or coke formation by using oxygen to partially oxidate the hydrocarbons.

The method and apparatus offers a possibility to treat carbon dioxide and carbon monoxide easily, and energy- and cost-effectively. The present invention provides an industrially applicable, simple and affordable way to produce carbon monoxide, and further to produce desired hydrocarbons by means of the FT reaction. The method and apparatus are easy and simple to realize in connection with production processes.

### EXAMPLES

### Example 1

FIG. 1 presents the method and also the apparatus for producing carbon monoxide (CO) from carbon dioxide (CO₂).

The carbon monoxide is formed from a gaseous feed (1) which comprises at least carbon dioxide. Oxygen (2) is supplied to a carbon dioxide stream (3) for forming a carbon dioxide based mixture (4). The carbon dioxide based mixture (4) is supplied to a hydrogen based stream (5) to form the gaseous feed (1). A hydrocarbon containing stream (6) is supplied to the hydrogen based stream (5) before the supply of the carbon dioxide based mixture (4) to the hydrogen based stream. The gaseous feed (1) is fed into a reactor (7) which comprises at least one catalyst. The gaseous feed is treated by means of a partial oxidation reaction in the reactor (7) with the catalyst so that carbon dioxide reacts with hydrogen in the reactor in presence of oxygen and heat is formed during the reaction. Simultaneously carbon dioxide is converted to carbon monoxide in the reactor. Product composition (8) comprising at least carbon monoxide and hydrogen is discharged from the reactor (7) and is recovered.

35

### Example 2

FIG. 2 presents the method and also the apparatus for producing carbon monoxide (CO) from carbon dioxide (CO₂) and hydrocarbons from the carbon monoxide.

The carbon monoxide is formed from a gaseous feed (1) which comprises at least carbon dioxide. Oxygen (2) is supplied to a carbon dioxide stream (3) for forming a carbon dioxide based mixture (4). The carbon dioxide based mixture (4) is supplied to a hydrogen based stream (5) to form the gaseous feed (1). A hydrocarbon containing stream (6) is supplied to the hydrogen based stream (5) before the supply of the carbon dioxide based mixture (4). The gaseous feed (1) is fed into a partial oxidation reactor (7), such as catalytic partial oxidation reactor (CPDX), which comprises at least one catalyst which may be Rh/Al₂O₃ catalyst or other suitable catalyst. Preferably, the Rh/Al₂O₃ has been washcoated on metal monolith. The gaseous feed (1) is fed with high velocity to the catalyst bed of the reactor (7) such that the velocity of the gas stream is about 1 m/s or over 1 m/s. The reactor (7) is a tubular reactor which is surrounded by an insulating covering. The gaseous feed is treated by means of a partial oxidation reaction in the reactor (7) with the catalyst so that carbon dioxide reacts with hydrogen in the reactor in presence of oxygen and heat is formed during the reaction. Simultaneously carbon dioxide is converted to carbon monoxide in the reactor. Temperature is preferably 800-950° C. and pressure is about 20 bar in the reactor (7). Product composition (8) comprising at least carbon monoxide and hydrogen is discharged from the reactor (7) and is recovered.

The product composition (8) is supplied as the feed to a Fischer-Tropsch (FT) reactor (9). The product composition may be cooled and water may be removed from the product composition before the FT reactor, e.g. by a condenser at pressure of about 20 bar. The temperature is 200-300° C. after the cooling. The Fischer-Tropsch (FT) reaction is an exothermic reaction in which carbon monoxide reacts with hydrogen and paraffin-rich hydrocarbons can be formed. Temperature is preferably 200-300° C. and pressure is about 20 bar in the FT reactor (9).

A product (10) of the FT reactor (9) is a mixture of hydrocarbons comprising C5-C60 hydrocarbons. The product of FT comprises desired components, such as oil and wax components, and undesired components, such as light hydrocarbons, unreacted feed components and/or non-condensable components or their combinations. An off-gas stream (11) comprising undesired components from the FT reactor (9) is recycled and is used as the hydrocarbon containing stream (6) in the feed of the partial oxidation reactor (7). The off-gas stream (11) comprises at least hydrocarbons, and it may comprise at least light hydrocarbons, preferably C1-C6 hydrocarbons.

Preferably, the pressure in the partial oxidation reactor (7) is same than the pressure in the FT reactor (9). Then the off-gases of the FT reactor can be recirculated to the partial oxidation reactor in which the off-gases can be processed to carbon monoxide.

### Example 3

The RWGS was studied in a pilot scale process with 37 l/min. A reactor of the pilot scale process corresponded to the reactor (7) of FIG. 1. The gaseous feed was supplied to the reactor. The equilibrium composition was achieved at temperature range 800 to 850° C. with linear flow velocity of 1 m/s using Rh/Al₂O₃ catalyst. The results are presented in Table 1.

TABLE 1

| Vₜₒₜ (in) | 36.5 | ln/min |
|---|---|---|
| Vₜₒₜ (out) | 25.1 | ln/min |
| P | 8.2 | bar |
| T_{cat} | 822 | ° C. |
| | Inlet vol-% | Outlet vol-% |
| H2 | 65.3 | 62.7 |
| N2 | 5.0 | 7.3 |
| CO | 0.0 | 20.3 |
| CO2 | 21.5 | 8.2 |
| CH4 | 3.0 | 1.5 |
| O2 | 5.1 | 0.0 |
| Total | 100.0 | 100.0 |

5

The devices and equipments of the process used in these examples are known per se in the art, and therefore they are not described in any more detail in this context.

The method and apparatus are suitable in different embodiments for treating carbon dioxide and for forming carbon monoxide from different kinds of feeds.

The invention is not limited merely to the examples referred to above; instead many variations are possible within the scope of the inventive idea defined by the claims.

1. A method for producing carbon monoxide, wherein the carbon monoxide is formed from a gaseous feed which comprises at least carbon dioxide, wherein the method comprises
supplying oxygen to a carbon dioxide stream for forming a carbon dioxide based mixture,
supplying the carbon dioxide based mixture to a hydrogen based stream to form the gaseous feed,
supplying a hydrocarbon containing stream to the hydrogen based stream before the supply of the carbon dioxide based mixture,
feeding the gaseous feed into a reactor which comprises at least one catalyst,
treating the gaseous feed by means of a partial oxidation in the reactor so that carbon dioxide reacts with hydrogen in the re-actor in presence of oxygen and heat is formed during the reaction, and
recovering a product composition comprising at least carbon monoxide and hydrogen from the reactor.

2. The method according to claim 1, wherein the gaseous feed is fed with high velocity to the reactor such that the velocity of the gas stream is ≥0.5 m/s.

3. The method according to claim 1, wherein a treatment temperature is 800-1500° C. in the reactor.

4. The method according to claim 1, wherein a treatment temperature is 800-950° C. in the reactor.

5. The method according to claim 1, wherein a pressure is 15-30 bar in the reactor.

6. The method according to claim 1, wherein the catalyst is selected from Rh/Al₂O₃ catalyst, NiRh/Al₂O₃ catalyst and Ni/Al₂O₃ catalyst.

7. The method according to claim 1, wherein the product composition is cooled after the reactor.

8. The method according to claim 1, wherein the product composition is supplied as the feed to a Fischer-Tropsch step.

9. The method according to claim 8, wherein the Fischer-Tropsch reaction is carried out at temperature which is 150-350° C.

10. The method according to claim, wherein pressure is 15-25 bar during the Fischer-Tropsch reaction.

11. The method according to claim 8, wherein an off-gas stream comprising at least hydrocarbons is recycled from the Fischer-Tropsch step to be used as the hydrocarbon containing stream.

12. An apparatus for producing carbon mon-oxide, wherein the carbon monoxide is formed from a gaseous feed which comprises at least carbon di-oxide, wherein the apparatus comprises
feeding devices for supplying oxygen to a carbon dioxide stream for forming a carbon dioxide based mixture, for supplying the carbon dioxide based mixture to a hydrogen based stream to form the gaseous feed and for supplying a hydrocarbon containing stream to the hydrogen based stream be-fore the supply of the carbon dioxide based mixture and for feeding the gaseous feed into a reactor,
at least one reactor which comprises at least one catalyst and to which the gaseous feed is supplied and in which the gaseous feed is treated by means of a partial oxidation so that carbon dioxide reacts with hydrogen in the reactor in presence of oxygen and heat is formed during the reaction, and
at least one recovering device for recovering a product composition comprising at least carbon monoxide and hydrogen from the reactor.

13. The apparatus according to claim 12, wherein the reactor is a tube reactor or a tubular reactor.

14. The apparatus according to claim 12, wherein the reactor is a catalytic partial oxidation (CPDX) reactor.

15. The apparatus according to claim 12, charactcrizcd in that wherein the apparatus comprises at least one Fischer-Tropsch re-actor into which the product composition is supplied.

16. The apparatus according to claim 15, wherein the apparatus comprises at least one recirculation device for recycling an off-gas stream comprising at least hydrocarbons from the Fischer-Tropsch step to be used as the hydrocarbon containing stream.

17. The method according to claim 1, used in at least one of:
a production of hydrocarbons,
Fischer-Tropsch process,
treatment of carbon dioxide,
carbon dioxide capture process,
catalytic partial oxidation process,
methanation process,
pro-duction of methanol, and
combinations thereof.
